(19) United States
(12) Patent Application Publication
(10) Pub. No.: US 2007/0188506 A1
(43) Pub. Date: Aug. 16, 2007

(54) Methods and systems for power optimized display

(76) Inventors: Lieven Hollevoet, Oostende (BE); Andy Dewilde, Oostduinkerke (BE); Francky Catthoor, Temse (BE)

Correspondence Address: KNOBBE MARTENS OLSON & BEAR LLP, 2040 MAIN STREET, FOURTEENTH FLOOR, IRVINE, CA, 92614, US

(21) Appl. No.: 11/504,824

(22) Filed: Aug. 11, 2006

Related U.S. Application Data
(63) Continuation of application No. PCT/BE05/00021, filed on Feb. 14, 2006.

(51) Int. Cl. G06T 1/60

(52) U.S. Cl. 345/530

(57) ABSTRACT

One inventive aspect relates to a display system for displaying information and a method for displaying. The system comprises a processing unit and a display unit comprising a display panel. On the image data processing path for transferring information to the display panel the number of writable memory components external to the display panel is limited to one. The writable memory component is adapted to store at least a single image frame. The systems and methods allow to reduce the power consumption based on reduction of the number of memory accesses. In another inventive aspect, a method and system is provided wherein updating of pixel information is performed content dependent. In still another inventive aspect, a system is provided wherein the display panel is connected to the processing unit using a separate, dedicated display bus.

### CROSS REFERENCE TO RELATED APPLICATIONS

This application is a continuation of PCT Application No. PCT/BE2005/00021, filed Feb. 14, 2006, which is incorporated by reference hereby in its entirety.

### BACKGROUND OF THE INVENTION

1. Field of the Invention

The present invention relates to devices and methods for displaying information. More particularly, the present invention relates to methods for displaying information having limited power consumption and devices or systems thus obtained.

2. Description of the Related Technology

The market for handheld devices has continued to grow ever since the breakthrough of cellular phones. Personal Digital Assistants (PDA's), mobile phones and portable multimedia players are just a few examples of battery powered devices that have a display unit as their main user interface. The display unit accounts for a considerable amount of the total power consumption. In non-emissive displays, the backlight is the major culprit there. On platforms equipped with standard color Liquid Crystal Displays (LCD's), the backlight unit consumes typically around 30% of the total power budget. As new emissive display units, i.e. display units without backlights, emerge, the data transfers required to put data on the screen start using up an increasingly important part of the platform's power. Typical examples of such displays are Light Emitting Diode Displays and Organic Light Emitting Diode (OLED) Displays.

An important factor in power consumption related to data transfer, corresponds with the number of memory accesses that are performed to put data on the screen. To put an image on the display, typically data is first written into a so-called video buffer or frame buffer. The frame buffer is typically used as the data source for a display controller unit, which scans the frame buffer and generates the control signals for the display panel. In current systems, a display system 100, as shown schematically by way of example in FIG. 1a, is shown with a display unit 102 seen as a separate building block of a multimedia terminal. From the application point of view, the display unit 102 is considered to be a black box. A typical application currently used for generating screen data writes its output from a processing unit 104 in the frame buffer 106. The output typically is first at least partly processed in a video memory 108. The frame buffer 106 typically is located in a main memory of the platform or in a memory unit contained within a display unit 102, furthermore comprising a display controller 110, such as e.g. an LCD controller unit. On systems where the display controller 110 is located on the main platform of the processing unit, such as e.g. in StrongARM and XScale processor based systems, the frame buffer 106 is integrated in the main platform and may be a part of the main memory. Refreshing the display panel 1112, such as e.g. the LCD panel, requires transferring the data from the main memory frame buffer 106 through the memory bus 114 to the display controller 110. This is typically done using a dedicated Direct Memory Access (DMA) controller contained within the display controller 110. The complete content of the frame buffer 106 then is transferred to the display controller 110 at a speed that is determined by the refresh rate of the display panel 112, e.g. 60 Hz or 75 Hz. This traffic places a heavy burden on the memory bus, and hence, on the power consumption of the platform. An overview of the bus connection for such a system 100 is shown in FIG. 1b. The advantage of using a processor-integrated display controller 110 is the reduction of the chip count of a system, an important factor in the design of portable devices. Disadvantages are the load on the main memory bus 114 and the power consumption caused by the bus accesses. In a typical system where the frame buffer 106 is located in the main memory, this part of the system accounts for 28% of the total power. In other words, in traditional systems, the memory accesses cause a significant power consumption, both in the memory chips themselves or memory units on the processing/display chips as in the busses that have to be driven to transfer the data between the chips. On the other hand, using a frame buffer allows designers to make abstraction of the display unit. In such a system view, the display controller, such as e.g. an LCD controller takes care of the hardware specific actions required to put an image on the screen. As long as energy or memory footprint is not an issue, this allows a simpler design procedure.

Various techniques for reducing the power consumption in a display system are currently used. Several of them are based on reducing frame buffer related memory accesses, such as variable-duty-ratio refresh and dynamic color depth control. Those methods reduce the power consumption by exploiting specific characteristics of the display elements, such as e.g. LCDs liquid crystal displays, with relation to the human eye. These methods leave the frame buffer present as a double or sometimes even triple buffered scheme.

Another technique includes the reduction of components used. U.S. patent application 2004/0263522 A1 describes a USB digital display system for displaying images, wherein one of the CPUs, typically used in displays, is removed for simplicity of the system. Removal of the CPU, reduces the number of process steps needed in the conversion from original image signals to displayed image data. In U.S. Pat. No. 6,535,985 a method for reducing power consumption is provided while performing required data processing operations. A specific processing unit may be de-energized according to timing or according to kind of input data. More specifically, if e.g. simple displaying actions need to be performed, the frequency by which the specific processing unit is activated can be significantly reduced, thus leading to a reduced power consumption.

Adjusting the refreshment of image data in a system, possibly in relation to the content of the data to be displayed, also allows for reducing power consumption in a display system. JP2000/356977 describes a method for reducing the load on a CPU by transferring only difference data between a previous frame and a present frame to a display driver. A similar system is described in U.S. Pat. No. 5,574,483 describing a method for reducing power consumption by reducing the number of accesses to the frame buffer, called video RAM's, for image portions in which the same contents are displayed. In this system, a certain pixel value is read from the video RAM and is converted to a control signal for the display panel. Once the control signal is applied to the display panel, it is verified if the next value in the video RAM corresponding with the information in the frame for the next pixel or screen area is the same. If this is the case, the same control signal is applied. In this way, subsequent display areas that have the same values in the video RAM can be updated without the need for determining a new control signal. In this way power consumption by the display control unit is reduced. A status RAM provides information about the contents between different frames. This info can be obtained at a writing time at which the CPU writes data to the video RAM.

Although the above mentioned techniques allow to reduce the power consumption, in battery powered embedded systems, the overhead incurred suntil is significantly large, such that further energy savings by using power optimized display solutions suntil are necessary.

### SUMMARY OF CERTAIN INVENTIVE ASPECTS

It is an object of certain inventive aspects to provide power optimized display systems as well as methods of operating the same.

The above objective is accomplished by a method and device according to certain inventive aspects based on a dedicated memory organization.

One inventive aspect relates to a display system for displaying information, the system comprising a processing unit and a display unit with a display panel, the display system having an image data processing path for transferring information to the display panel, wherein the image data processing path comprises at most one writable memory component external to the display panel, the writable memory component adapted for storing or buffering at least a single image frame.

The display system may comprise one writable memory component.

The writable memory component may be a single port memory component. The writable memory component may comprise different memory elements that can be contacted all through the same memory port. The system furthermore may comprise a control unit adapted to control access of the one writable memory component. The control unit may be implemented in hardware or in software.

The one writable memory external to the display panel, e.g. the frame buffer memory, should preferably not be a dual-port memory component, i.e. for example it is not a dual-port frame. In other words reading information from the one writable memory external to the display panel by the display panel may be not possible simultaneously with writing information to the one writable memory external to the display panel by the processing unit. The control unit may control the processing unit and the display panel such that they never access the information at the same time, and that the production of new pixels from the processing unit, i.e. the generation or transmission of the new image to the one writable memory external to the display panel, may be postponed until the display has read the pixels of the current image from the one writable memory external to the display. This one writable memory external to the display may be a single-buffered memory. The memory may be capable of comprising only one image frame of the information to be displayed.

The writable memory component may be a frame buffer. The frame buffer may be integrated in the display unit. Alternatively, the frame buffer may be positioned on a main platform of the display system, where the processing unit is located.

The writable memory component may be a video RAM. This video RAM may be located on the main platform of the display system. It may be part of a larger memory.

The display system may comprise no writable memory component external to the display panel on the image data processing path.

The display panel may comprise a plurality of pixels, and the display system may comprise a writable memory component in the display panel, the writable memory component in the display panel comprising a memory cell for each pixel of the display panel. In other words, the memory cells corresponding with the pixels of the display panel may be used as writable memory in the image data processing.

The display unit may comprise an active matrix display panel. The display unit may comprise a fixed format display panel. The display unit may comprise any display with an array of pixels whereby every pixel has a memory element associated with it, e.g. a capacitor.

The display unit may comprise a liquid-crystal-on-silicon based (LCOS) device.

The display unit may comprise any of an organic light emitting device or a light emitting diode device.

The display unit may comprise a thin film transistor based display panel.

Access to the display unit, e.g. to the on-display memory component, may be organised via the memory map within the processing unit.

The display system may be adapted to store digital or analog values for each pixel of the display panel.

The display system may comprise a conversion unit for transforming digital outputs received in the processing unit, to analog values suited for the display unit.

The display unit may be directly connected to the processing unit. More particularly, the display panel may be directly connected to the processing unit.

The direct connection may be made by a first bus.

The writable memory component external to the display panel may be connected to the processing unit by a second bus. The number of memory accesses, e.g. writes from the processing unit, may be minimized so that only the “new updates” are overwriting the “current image info” in the one writable memory component external to the display panel. So not only the display itself may be only “reading” the modified pixels from the buffer. Also the transfer from the processing unit to the one writable memory component external to the display panel, e.g. the frame buffer, may be optimized by only transferring the modified pixel display data to the one writable memory external to the display panel, e.g. the frame buffer.

The first bus and the second bus may have no parts in common.

One inventive aspect furthermore relates to a display system for displaying information, the system comprising a processing unit and a display unit, wherein the display unit is directly connected to the processing unit.

The direct connection may be made by a first bus connection.

The first bus connection may be a dedicated display bus connection.

The display unit may comprise a display panel and the display system may comprise at most one writable memory component external to the display panel and adapted for comprising at least a single image frame, the writable memory component external to the display panel being connected to the processing unit through a second bus, the second bus having no common part with the first bus.

The display unit furthermore may be powered by a driver bus.

The display unit may comprise a fixed format display panel. The display unit may comprise any of a liquid-crystal-on-silicon based display panel, an organic light emitting device display panel or a light emitting diode display panel.

The display panel may be a thin film transistor based display panel.

The display panel may comprise a plurality of pixels, wherein the display system may be adapted to store digital or analog values for each pixel of the display panel.

The display system furthermore may comprise a conversion unit for transforming digital outputs of the computation unit to analog values suited for the display unit.

Access to the display panel may be organized via a memory map in the processing unit.

One inventive aspect also relates to a method for displaying information, the method comprising receiving in a processing unit information to be displayed,

converting the information in an image to be displayed, displaying the image to be displayed, wherein converting the information in an image to be displayed comprises converting the information in an image to be displayed using at most one writable memory component external to the display panel. The method may be applied in any of the display systems, as described above. Converting the information in an image to be displayed may comprise controlling the access to the writable memory component external to the display panel. Converting the information in an image to be displayed may comprise converting the information in memory information for the memory elements corresponding to pixels of the display panel.

One inventive aspect furthermore relates to a method for displaying information, the method converting information into framed image sequences, the method comprising computing an image whereby at least one pixel value for a new frame is determined and updating pixel display data only when the pixel display data are changed.

Updating pixel display data only when the pixel display data are changed may comprise transferring only the updated pixel display data to pixels of a display panel.

The updating pixel display data only when the pixel display data are changed may furthermore comprise transferring only the updated pixel display data to a writable memory component external to the display panel.

Transferring only the updated pixel display data to pixels of a display panel may comprise updating pixel display data to the corresponding memory cells of the pixels of the display panel.

Updating pixel display data may comprise determining at least one pixel address based on a memory map in the processing unit.

Computing an image may be based on taking into account the memory model of the display unit and the particular constraints of such display units.

The information may be video information.

The video information may be block oriented video information, each block comprising a header. Computing an image may comprise indicating in the block which pixel information has been changed.

In one inventive aspect, a method of modifying a data source for an application is provided. The method comprises reducing, for power reduction, a plurality of memory accesses for displaying data on a display panel by producing new data in the data source not slower than sending previously produced data to the display panel.

It is an advantage of one inventive aspect that the systems and methods of certain embodiments are specifically useful for handheld user terminals.

It is also an advantage of one inventive aspect that the systems and methods of the different embodiments are specifically useful for use with displays based on a dedicated memory organization, such as e.g. fixed format displays.

Some inventive aspects are set out in the accompanying independent and dependent claims. Features from the dependent claims may be combined with features of the independent claims and with features of other dependent claims as appropriate and not merely as explicitly set out in the claims.

Although there has been constant improvement, change and evolution of devices in this field, the present concepts are believed to represent substantial new and novel improvements, including departures from prior practices, resulting in the provision of more efficient, and reliable devices of this nature.

The teachings of certain inventive aspects permit the design of improved methods and apparatus for battery powered display systems having a reduced power consumption.

These and other characteristics, features and advantages of certain inventive aspects will become apparent from the following detailed description, taken in conjunction with the accompanying drawings, which illustrate, by way of example, the principles of certain inventive aspects. This description is given for the sake of example only, without limiting the scope of certain inventive aspects. The reference figures quoted below refer to the attached drawings.

### BRIEF DESCRIPTION OF THE DRAWINGS

FIG. 1a is a schematic overview of a conventional display system comprising a frame buffer and a video memory as known from the prior art.

FIG. 1b shows the typical bus connection for a prior art display system as described in FIG. 1a, wherein the display unit is connected to a processing unit using at least part of the memory bus used for connecting the frame buffer with the processing unit.

FIG. 2 is a schematic representation of a display system having an image data processing path between a processing unit and a display panel with at most one writable memory, according to a first embodiment.

FIG. 3 illustrates a memory map for allowing addressing of pixels of a display panel, according to embodiments one to four.

FIG. 4a and FIG. 4b show a display system, with alternative positions for the frame buffer, being the sole writable memory on the image data processing path, external to the display panel, according to a first embodiment.

FIG. 4c and FIG. 4d illustrate different ways for connecting the different components of the display system as shown in FIG. 4a or FIG. 4b, either using part of a memory bus to connect the display unit (FIG. 4c), or using a separate display bus (FIG. 4d).

FIG. 5a shows a schematic illustration of a display system wherein the frame buffer is omitted and the video RAM is the sole writable memory on the image data processing path, external to the display panel, as an alternative system according to the first embodiment.

FIG. 5b and FIG. 5c illustrate different ways for connecting the different components of the display system as shown in FIG. 5a, either using part of a memory bus to connect the display unit (FIG. 5b), or using a separate display bus (FIG. 5c).

FIG. 6a shows a schematic illustration of a display system wherein no writable memory components are present on the image data processing path, external to the display panel according to a second embodiment.

FIG. 6b illustrates a way for connecting the different components of the display system as shown in FIG. 6a, wherein the display unit is directly connected to the processing unit.

FIG. 7a shows a schematic illustration of a display system according to the display system of FIG. 6a, wherein the display unit allows for reading back.

FIG. 7b illustrates a way for connecting the different components of the display system as shown in FIG. 7a, wherein the display unit is directly connected to the processing unit with a two way communication.

FIG. 8a shows a schematic representation of a display system, the display system comprising a display unit comprising only a display panel without display controller as an alternative example according to the second embodiment.

FIG. 8b illustrates a way for connecting the different components of a display system as shown in FIG. 8a, wherein the display unit is directly connected to the processing unit.

FIG. 9a shows a schematic representation of a display system according to FIG. 8a, wherein furthermore a separate bus driver is provided for compensating leakage of the memory elements of the display panel.

FIG. 9b illustrates a way for connecting the different components of a display system as shown in FIG. 9a, wherein the display unit is directly connected to the processing unit.

FIG. 10 illustrates the different steps of a method for power optimized displaying according to a fifth embodiment.

FIG. 11 illustrates a way for connecting different components of a display system as known from the prior art.

FIG. 12 illustrates a way for connecting different components of a display system wherein a specific bus is used for connecting the processing unit with the display unit, according to a fifth embodiment.

FIG. 13a and FIG. 13b are two examples of the way for connecting different components of a display system as shown in FIG. 12.

FIG. 14 is an illustration of the power gained by optimizing compared to the original power consumption.

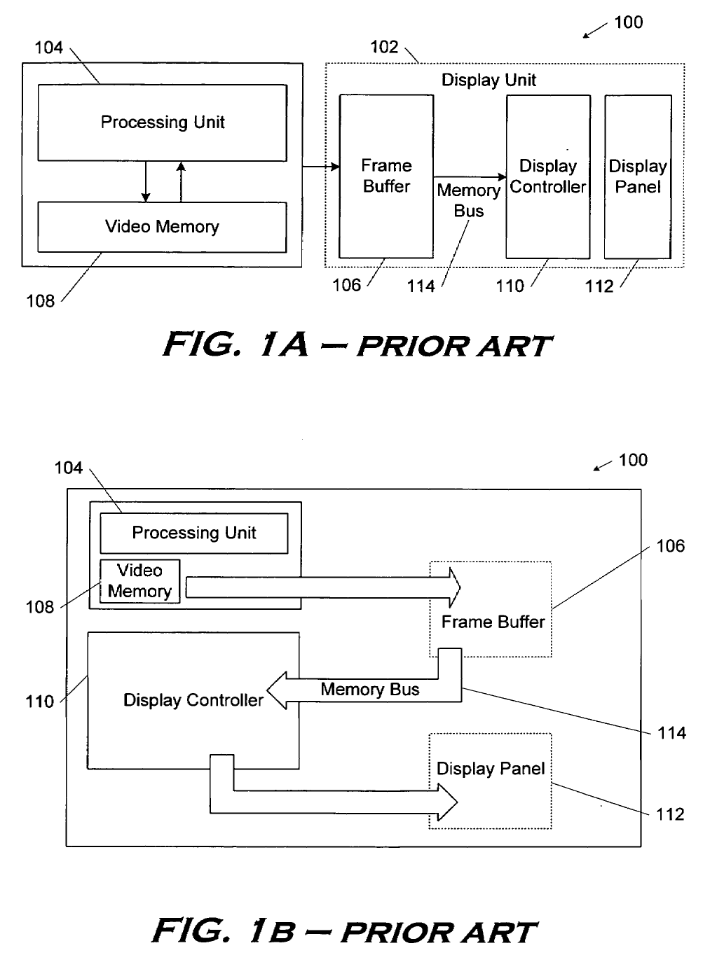

In the different figures, the same reference signs refer to the same or analogous elements.

### DESCRIPTION OF ILLUSTRATIVE EMBODIMENTS

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions do not correspond to actual reductions to practice of the invention.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments described herein are capable of operation in other orientations than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to that description, the only relevant components of the device are A and B.

Similarly, it is to be noticed that the term “coupled”, also used in the claims, should not be interpreted as being restricted to direct connections only. Thus, the scope of the expression “a device A coupled to a device B” should not be limited to devices or systems wherein an output of device A is directly connected to an input of device B. It means that there exists a path between an output of A and an input of B which may be a path including other devices or means.

The invention will now be described by a detailed description of several embodiments. It is clear that other embodiments can be configured according to the knowledge of persons skilled in the art without departing from the true spirit or technical teaching of the description, the invention being limited only by the terms of the appended claims.

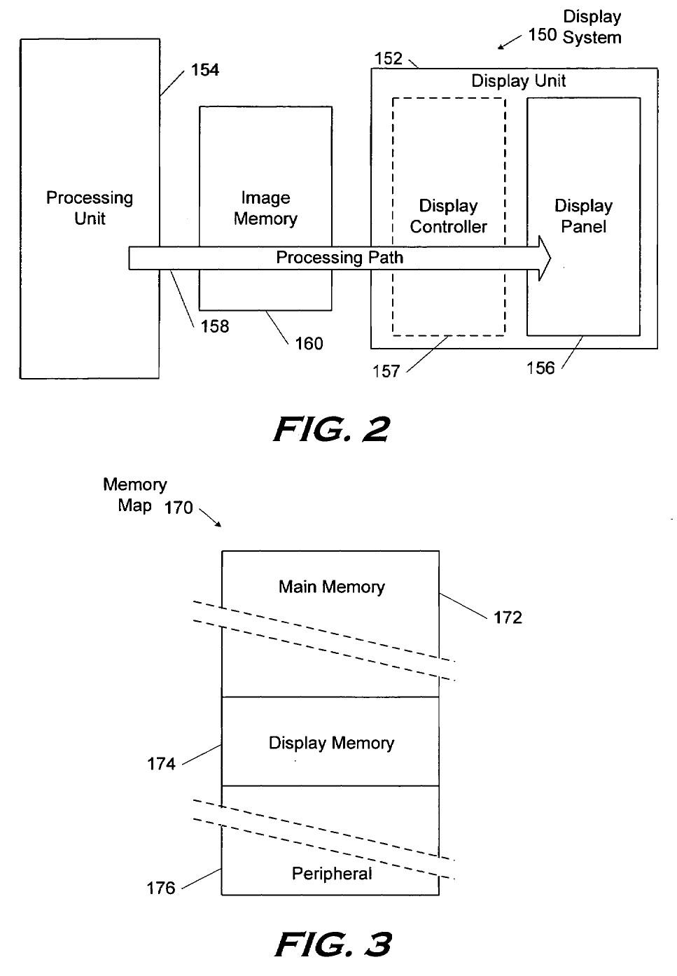

In a first inventive aspect, a display system is described wherein the number of intermediate memories, between a processing unit, such as a microprocessor, and the display panel, is limited. In this way a display system with low power consumption and a method of operating the same is provided. FIG. 2 illustrates, by way of example, a display system 150, the display system 150 comprising a display unit 152 and a processing unit 154. The display unit 152 comprises at least a display panel 156. The display unit 152 optionally may or may not comprise a display controller 157. In the processing unit 154, information is generated or received to be displayed on the display panel 156. The processing unit 154 may be any suitable processing unit such as e.g. a part of a central processing unit (CPU), a micro-computer or any other units comprising logic elements and control elements which allow to process data, for example digital signal processing, compression, decompression, coding, decoding, scaling, skewing, etc. The information then is processed to data to be displayed on the display panel 156 according to a specific image data processing path 158. In contrast to prior art display systems, the present display system 150 provides maximally one writable image memory 160 along the image data processing path 158 external to the display panel 156. In other words, either one writable image memory component 160 external to the display panel 156, or no writable image memory component 160 external to the display panel 156 is present. In other words, at least one of the video RAM present on the main platform and of the frame buffer, typically both present in prior art systems, is eliminated in the present display system. The display panel 156 itself may act and actively be used as a memory. The writable image memory component 160 may be any writable memory component that is adapted for comprising a single image frame. Typical examples of such writable memory components are random access memory (RAM) memory, such as e.g. dynamic RAM and static RAM, DRAM, SRAM, EDO RAM, EDRAM, etc., by way of example. The reduction of intermediate memories allows to obtain an improved power consumption, i.e. the power consumption is reduced e.g. as an optimized throughput is obtained to the display panel 156 and/or as the necessary memory size may be reduced.

A typical way of obtaining a reduction of intermediate memories between the processing unit 154 and the display panel 156, is by treating the display panel 156 itself as a memory. For example, for this purpose a memory element is asociated with each pixel of a fixed format display and is used as a memory store. The latter allows for a reduction of intermediate memories, as the requirements for bringing the display output data in specific display format is overcome. The display system 150 thus has a new hardware architecture comprising a display panel 156 which actually may be used as video memory. The display panel 156, used as a video memory is based on integration techniques, wherein a memory is integrated at the pixel level. In other words, a pixel-level memory is present for each pixel of the display panel 156. Typical display panels 156 having such a memory element incorporated for each pixel, are e.g. display panels 156 with active pixels, also referred to as active matrix display panels, as these comprise at the pixel level an electronic component including a memory element such as a storage capacitor local to each pixel, or display panels wherein for each pixel a memory element is specifically included. Typical examples of such display panels 156 comprising an integrated pixel-level memory are thin film transistor display panels. Specific types of display panels that can be used are e.g. OLED display panels, LED display panels, LCD display panels, etc. The display panel that can be used may e.g. be a reflective display such as e.g. a system based on LCOS valves, wherein the memory cell is hidden behind the pixel. The status of pixels in the display panel 156 is then determined by the value that is written in the corresponding memory cell. Switching a pixel on or off occurs by writing a certain value to the corresponding memory location on the display panel. In more advanced display panels, a shadow memory element may be additionally provided, that allows storing information of a frame subsequent to the current frame that is displayed. The display panels used preferably are fixed format display panels, such that the number of memory elements per display panel is known.

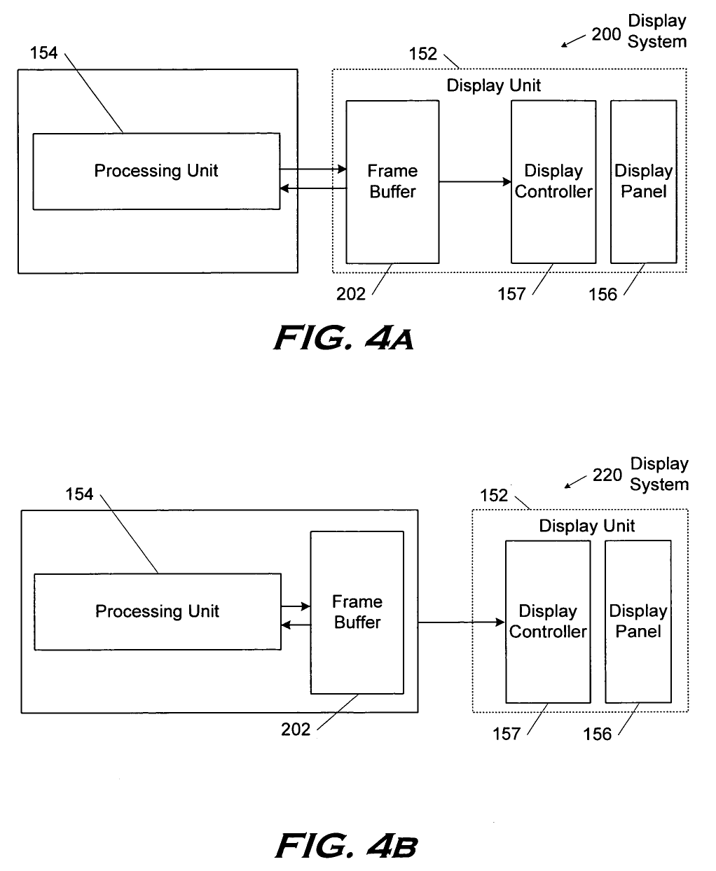

In order to allow good operation of such a system, the processor memory then is equipped with a processors memory map comprising information about the display memory map addresses. Updating pixels on the screen then is performed by updating the corresponding memory locations in the display memory. A schematic representation of such a memory map is shown in FIG. 3. The memory map 170 provides for the main memory 172 the necessary information about the display memory addresses in the display memory 174 present in one of the peripherals 176, such as e.g. a display unit, a PDA, a mobile phone, etc. The display panel thus acts as a large Random Access Memory (RAM) to the processor, thereby fully exploiting the fact that a memory cell is present for every pixel on the screen. This memory may be write only or may also be read/write if the necessary access coders are provided. The display system according to the first inventive aspect may be adapted for processing the information to be displayed on the data processing path such that the information to be displayed is converted in memory information, suitable for the memory elements of the pixels of the display panel. It will be appreciated that a dedicated display has been provided for the processor rather than providing an output of the processor which can be used with any display.

In a display panel used as a memory, both monochrome as well as color images can be represented. Introduction of color can be provided by displaying combinations of values in different memory cells corresponding with different adjacent colored pixels (e.g. a set of primary color pixels such as three pixels for red, green, blue) thus regarding the group of colored pixels, e.g. the set of primary color pixels such as three pixels for red, green, blue, as a superpixel. Introduction of grey levels and/or color levels can be provided by displaying combinations of values in different memory cells corresponding with adjacent pixels (e.g. a cell of n pixels) thus regarding the group of pixels, e.g. the cell of n pixels, a superpixel. By combining the values in different memory cells, different grey levels and/or a different color can be displayed.

By way of example, different embodiments will be described wherein the number of intermediate memories is reduced compared to prior art display systems.

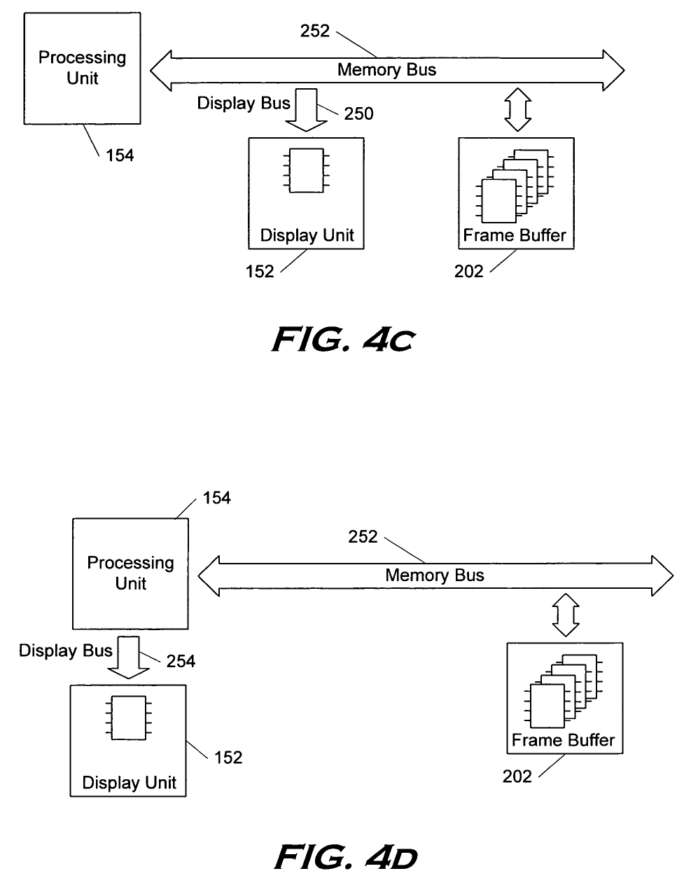

Referring to FIG. 4a, in a first embodiment, a display system 200 is described, wherein one of the frame buffer or the video RAM on the main platform is not provided, such that there is only a single writable memory external to the display panel 156, between the processing unit 154 and the display panel 156.

Not providing, i.e. eliminating compared to prior art systems, the video RAM on the main platform is shown in FIG. 4a and FIG. 4b. These figures show the structural components of the display system 200, 220. The display system 200, 220 comprises a display unit 152 with a display panel 156. The display system 200, 220 furthermore comprises a processing unit 154 on a main platform, e.g. a motherboard, and a frame buffer 202. The display unit 152 furthermore may optionally comprise a display controller 157. The frame buffer 202 may be located either in the display unit 152, as part of the display controller 157, as shown in FIG. 4a or it may be located on the main platform as shown in FIG. 4b. When the frame buffer 202 is integrated in the display controller 157, the display controller 157 acts as a separate building block accessible to the processor 154.

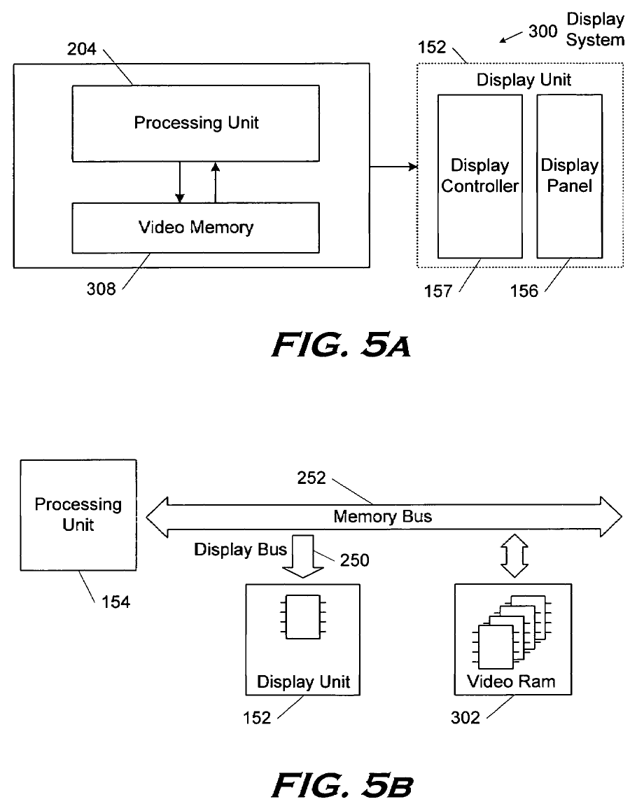

Alternatively, the frame buffer is not provided and the video RAM 308 of the main platform is the writable memory on the image data processing path external to the display panel 156. The latter is shown for display system 300, shown in FIG. 5a. The display system 300 comprises a display unit 152 with a display panel 156. The display system 300 furthermore comprises a processing unit 204 on a main platform, e.g. a motherboard, and a video memory 308. The display unit 152 furthermore may optionally comprise a display controller 157. This allows for important power savings as the high throughput bus between the frame buffer and the display panel 156 is not required any more. The one writable memory on the image data processing path may be adapted for comprising at least a single image frame. Furthermore, the one writable memory component on the image data processing path may be a single port memory, meaning that it can only be contacted for reading or writing through a single port. It is to be noted that several memory elements contacted through the same, single port, may be considered as one writable memory component. It is an advantage that at least one intermediate memory is not provided anymore, as this may allow, e.g. if a frame buffer allocated in the main memory is not provided or if a video RAM allocated in the main memory is not provided, a reduction of the required main memory size of a platform. This enables designers to switch off memory banks that are not in use, which reduces the required memory footprint and further optimizes the power consumption. Reduction of the needed memory for displaying is advantageous when the power required to keep a memory chip active is a significant part of the total power available, e.g. in systems where the power required to keep a memory chip active is dominant.

For both hardware configurations, different and alternative methods for interconnecting the different components of the display system are shown in FIG. 4c, FIG. 4d, FIG. 5b and FIG. 5c. FIG. 4c and FIG. 5b show a connection between the processing unit 154 and the display unit 152 by a display bus 250 connection which uses part of the memory bus 252, i.e. the connection between the processing unit 154 and the writable memory, such as the frame buffer 202, as shown in FIG. 4c, or the video RAM 302, as shown in FIG. 5b. In this case, there is no direct connection between the processing unit 154 and the display unit 152, as the display bus 250 and the memory bus 252 have shared parts. When the frame buffer 202 is integrated in the display controller, the load involved in refreshing the display may be removed from the main memory and system bus since the data traffic may be routed from the internal frame buffer to the display panel 156 through a separate bus. The advantage of this way of working is that the main memory bus is free for other subparts of the system and that the power consumption of the bus accesses, required to refresh the display panel 156, is reduced. The dedicated bus is shorter and less complex than the system bus and hence, it will pose a smaller load on the system's power consumption.

Alternatively, direct connection between the processing unit 154 and the display panel 156 may be provided. In this case a dedicated display bus 254 is provided for directly connecting the processing unit 154 and the display panel 156. No use is made of the memory bus 252 or part of the memory bus 252 connecting the processing unit 154 to the one writable memory. In other words, the memory bus 252 and the dedicated display bus 254 have no common parts. A separate driver bus for the display panel may furthermore be provided to provide power compensation for the leakage of the memory elements or to power the switches for the pixels of the display panel.

The display system described in the first embodiment, wherein one writable memory external to the display panel is present on the data processing path between the processing unit and the display panel, is suitable both for streaming video, i.e. wherein near-instantaneous delivery of various kinds of media, such as e.g. moving images, camera, mobile streaming media, digital or analog television, etc. as well as video or moving images obtained from a memory where it is locally stored. On the other hand, the system also can be used for for suntil images or a sequence thereof.

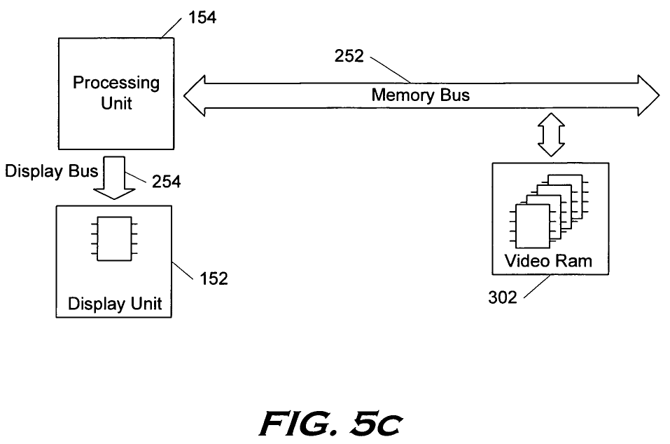

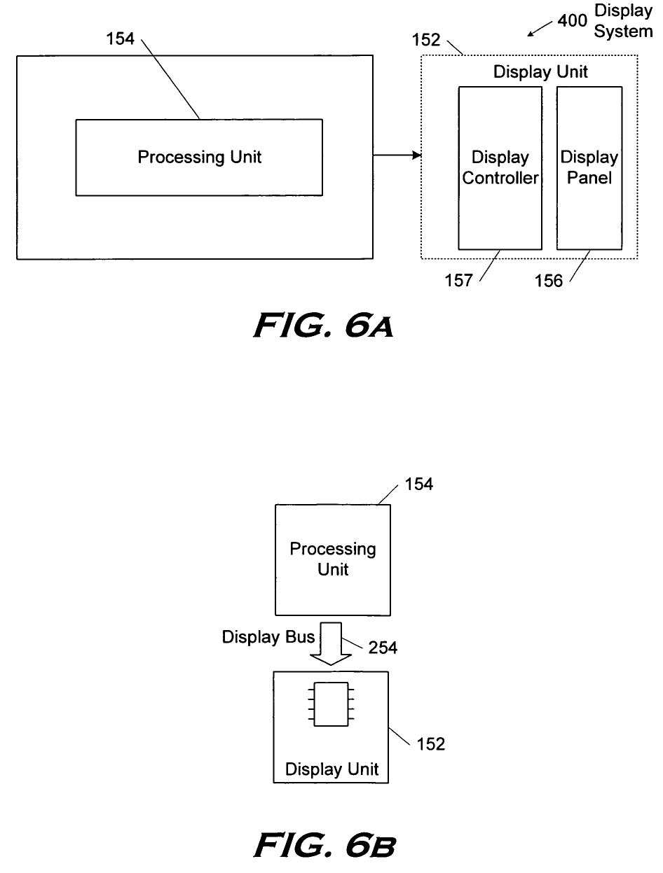

A second embodiment provides a display system 400, 450, 500, 550 wherein no writable memory external to the display panel 156 is present in the image data processing path between the processing unit 154 and the display panel 156. In other words, both the frame buffer as well as the video RAM is not provided, in contrast to prior art systems. The processing unit 154 is directly connected to the display unit 152, comprising a display panel 156. In FIG. 6a and FIG. 7a, an example of such a display system 400, 450 is shown, wherein the display unit 152 furthermore comprises a display controller 157. Whereas in FIG. 6a, only information can be written to the display unit 152, i.e. to the memory cells corresponding with the pixels of the display panel 156, in FIG. 7a, a display unit is shown wherein information can both be written to as read from the display unit 152 or more particularly to and from the memory cells corresponding with the pixels of the display panel 156.

FIG. 6b and FIG. 7b show the respective connection between the processing unit 154 and the display unit 152 for both the display systems shown in FIG. 6a and FIG. 7a. The display busses shown provide the direct connection between the processing unit 154 and the display unit 152, which may be considered as a dedicated display bus. This bus can be a memory bus, as the present is not loaded or overloaded by a connection between the processing unit 154 and a writable memory. In FIG. 6b, a one way communication bus is provided, whereas in FIG. 7b, a two way communication bus is provided. In the latter case, both information can be written to the display unit 152 and information can be read from the display unit by the processing unit 154. Although not explicitly shown, an additional driver bus may be provided to solve for e.g. leakage of the memory cells or switches of the display panel 156.

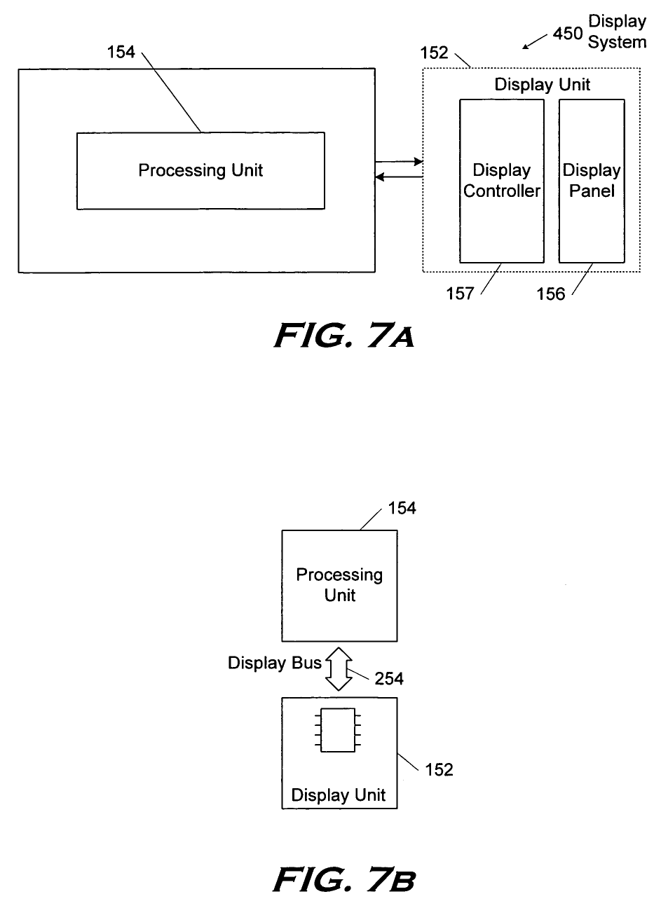

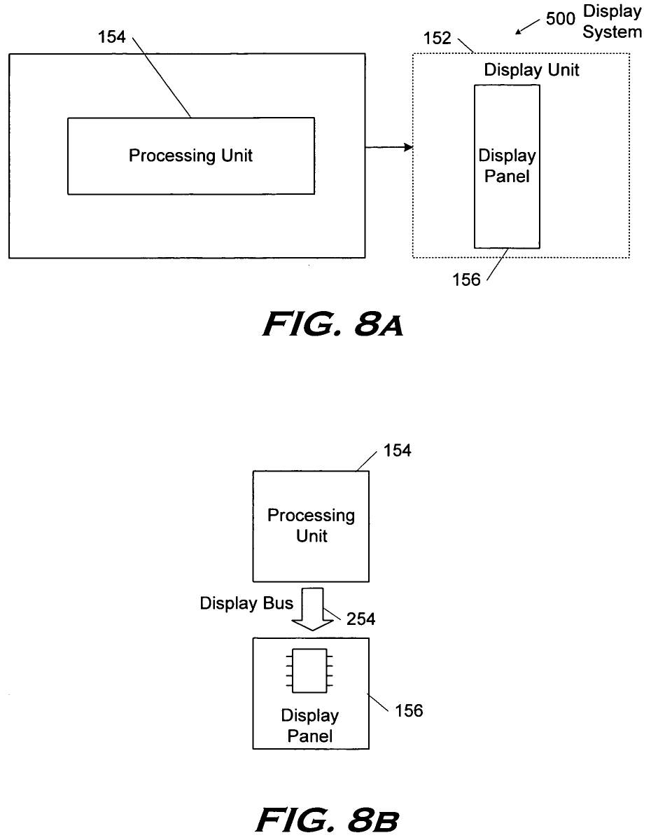

In FIG. 8a and FIG. 9a, a display system 500, 550 is shown comprising a processing unit 154 and a display unit 152 comprising a display panel 156. In these embodiments, no display controller is provided. The display panel 156 may be provided with an additional driver bus 552, as shown in FIG. 9a. FIG. 8b and FIG. 9b show how the connections between the different display components of the display system 500, 550 may be made. A direct connection between the processing unit 154 and the display panel 156 is provided, using a bus. This may be considered as a dedicated display bus, or as a memory bus as it provides connection between the processing unit 154 and the display memory. Furthermore, as discussed above and also shown in FIG. 9b, an additional driver bus 552 may be provided to solve for leakage of the memory elements or switches provided for the pixels of the display panel.

In systems according to the second embodiment, the only video related memory that is required is the memory that exists on the display panel itself, for example an array of memory elements, each memory element being located at a pixel of a fixed format display. The display panel according to the present embodiment thus is treated as an item of memory, for example it can be plugged directly onto a memory bus of an embedded processor or of a standalone computing and/or communications device such as a PC, laptop, PDA, mobile phone, smart phone. The display may be plugged directly onto a motherboard of a PC. The display panel thus may be plugged directly onto the memory bus.

Although the invention is not limited thereto, the display systems described in the second embodiment are especially useful for media with a low new data rate, such as still images or a sequence thereof, or video wherein the new data rate is low such as e.g. in the use of a worksheet or text application, in an application showing a fixed image combined with a relatively slow changing image, etc.

It is an advantage of the display systems that use the display panel as a memory according to the above described embodiments, that the video signal is sent as a series of memory frames and can be displayed as if the display panel was a memory. The video signal therefore does not require additional information which has been used in the past by CRT's, e.g. blanking periods, horizontal and vertical sync signals. A display in accordance with the description herein can display an arbitrary image, e.g. a video optionally in color. Consequently, less information needs to be provided in order to obtain the correct displaying of images on the display panel.

In a third embodiment of the first inventive aspect, the system described in the previous embodiments is combined with a method for further reducing the power consumption, by only changing those pixels of a fixed format display that need to be updated because the information to be displayed by the pixel is to be changed. In prior art video interface methods, the refresh of the display generates a large part of the total memory traffic and bus usage. Refreshing e.g. a 640×480 pixel, 60 Hz display that uses 18 bits to represent one pixel, generates a 316 Mbits per second load in the memory units and bus between the frame buffer and the LCD panel. The consequences in power consumption are considerable: 6% of the total system power is needed to drive the LCD panel bus, the frame buffer accounts for 19% of the total power. An important power saving is obtained by avoiding refreshing of the pixels, which are not updated. With updating of a pixel, there is meant that the pixel needs to display other information than previously. Using a fixed format display panel with pixel-level memories allows to easily reduce the refreshing of pixels by only writing new information to memory cells corresponding with pixels to be updated, i.e. by only changing the information in a memory cell when the information for that memory cell is changed.

A fourth embodiment provides a display system 150 according to the first embodiment, having one writable memory component external to the display panel 156, whereby the display system 150 furthermore is adapted for controlling the access to the writable memory component, which may be e.g. a frame buffer. The one writable memory component, external to the display panel 156, typically is a single port memory component, in contrast to dual-port memory components often used in the prior art to provide a certain flexibility in design of the display system 150. The single port memory component thus typically is not able to both read information from the processing unit 154 and provide information to the display panel simultaneously, i.e. at the same time. In other words, reading and writing cannot be performed in parallel as there is only one memory port. Reading from and writing to the single port memory thus needs to be performed alternatively. In order to control the access to the one writable memory component external to the display panel 156, the display system 150 comprises a control unit adapted to control the access to the memory component. This control unit may be implemented both in hardware or in software. The control unit may time the read and write demands to the frame buffer such that reading and writing is not performed in parallel or in other words, the control unit may control the processing unit 154 and the display panel 156 such that they never access the information at the same time, and that the production of new pixels from the processing unit 154, i.e. the generation or transmission of the new image to the one writable memory external to the display panel 156, may be postponed until the display panel 156 has read the pixels of the current image from the one writable memory external to the display. This one writable memory external to the display may be a single-buffered memory. In other words, the memory may be capable of comprising only one image frame of the information to be displayed. This single-buffered memory is especially useful in combination with a memory component comprised in the display panel 156, built up from the different memory cells of the display panel 156 which are corresponding to the different pixels of the display panel 156.

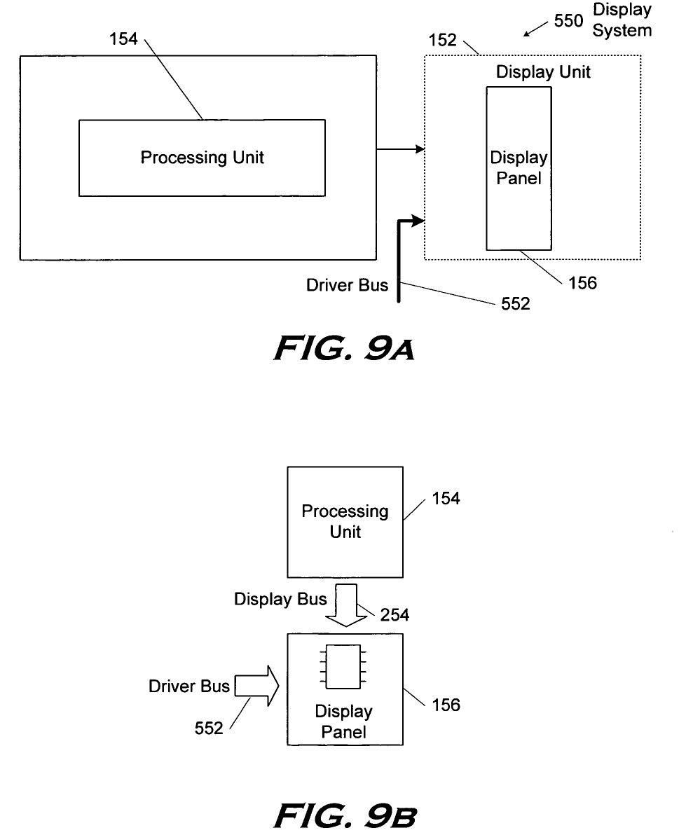

A fifth embodiment according to the first aspect relates to a method for driving a power optimized display. The method comprises different steps, as shown in FIG. 10. In a first step 572, the method 570 comprises, receiving information to be displayed in a processing unit 154. The information to be received may be either still images or it may be video like information. The information furthermore may be received from a storage location where it is stored, or the information may be received as streaming data. The information is received in a processing unit 154 which may be e.g. a microprocessor or a CPU, although the processing unit 154 is not limited thereto. In a second step 574 the received information is converted in an image to be displayed. This converting step 574 comprises the processing of the information to be displayed, e.g. in image frames. The present method 570 thereby is characterized in that this converting of the information to be displayed is performed using only 1 writable memory component external to the display panel. The latter allows to significantly reduce the number of memory accesses, thus allowing to reduce the power consumption of the system. The present step 574 especially can be performed in systems as described in the previous embodiment of the first inventive aspect. These systems thereby actively use the memory cells of the pixels of the display panel as part of the display data processing unit. This converting step 574 thus comprises converting the information to be displayed in memory information suitable for the memory component built up from the memory cells of the pixels of the display panel 156. After the information to be displayed is converted in the appropriate memory information, the appropriate memory information is written to the memory cells of the display panel, thus allowing to create an image on the display panel. The latter is performed in step 576. The information thereby may be immediately displayed by the pixel as soon as the memory cell is written.

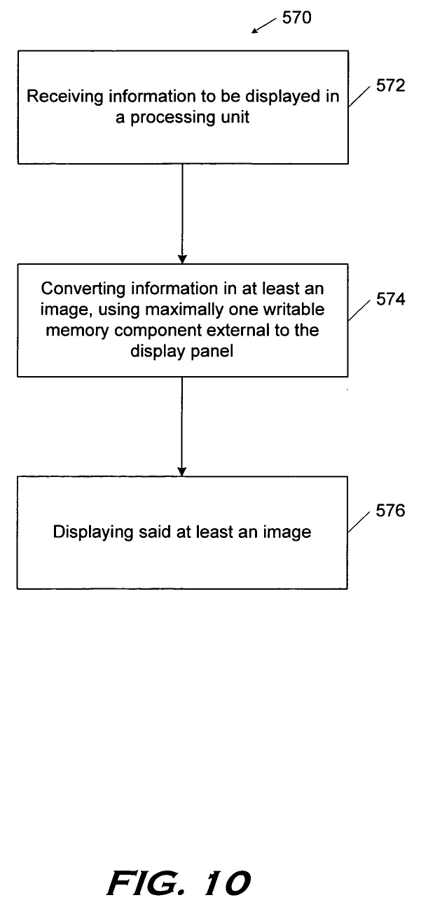

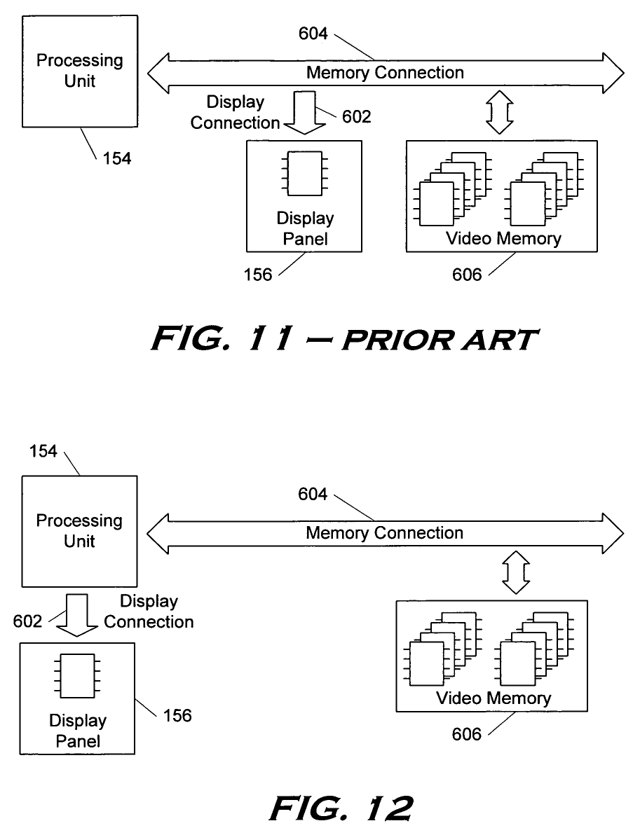

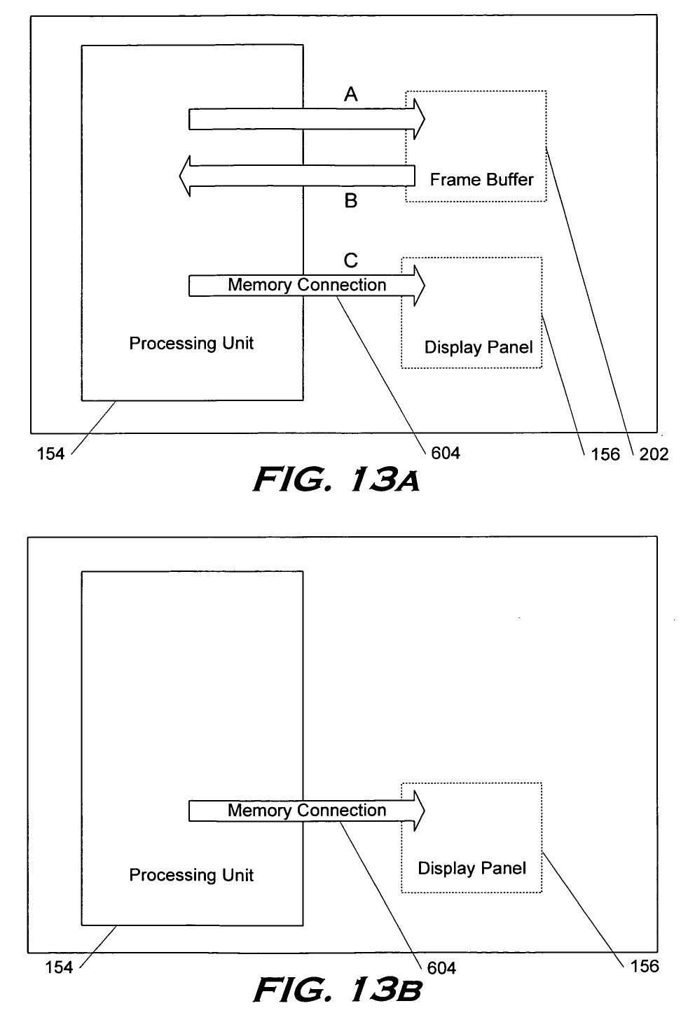

A second inventive aspect relates to a display system 600 with lower power consumption, whereby the reduced power consumption is obtained by shifting the display panel of the display system to a separate bus on the processor. In other words, in the second inventive aspect, the processor is directly connected to the display unit, without using the memory bus or part thereof. Whereas the typical connection in prior art display systems 600a is shown in FIG. 11, the connection between the different components of the display system 600b according to the second aspect is shown in FIG. 12. In prior art display systems 600a, a display connection 602 is provided between the processing unit 154 and the display panel 156 which uses part of the memory connection 604 between the processing unit 154 and the video memory 606 external to the display panel, which may be e.g. a video RAM on the main platform or e.g. a frame buffer. In prior art systems 600a, the information traffic between the processing unit 154 and the display panel 156 thus provides an additional load on the memory connection 604, typically a memory bus. In the second inventive aspect the display connection 602 between the processing unit 154, which may e.g. be a CPU, and a display panel 156, are different from the memory connection 604 between the processing unit 154 and the video memory 606 external to the display panel. In other words, the display connection 602 between the processing unit 154 and the display panel 156, and the memory connection 604 between the processing unit 154 and the video memory 606 have no common part. The latter is obtained by providing a separate bus for different peripherals, e.g. whereby one peripheral is a display panel 156, and the second peripheral is a video memory 606 such as e.g. a frame buffer. A separate bus for connecting the display panel 156 may be called a dedicated display bus, as it provides a direct connection between the processing unit and the display panel. In this way, the processing unit 154 can access different peripherals using different busses, thus decreasing the load on the memory bus, which results in an improved low power consumption. The specific display system architecture and the method of connecting different components to the processing unit using different busses may be applied to the different embodiments described in the first inventive aspect. Some examples are shown in FIG. 13a and FIG. 13b, wherein a dedicated display bus 604 is shown, both for a display system with and a display system without additional external video memory, such as e.g. a frame buffer 202, external to the display panel 156.

A third inventive aspect relates to a method for reducing the number of memory accesses, whereby advantage is taken of the content of the data that is displayed on the screen. It seldom occurs that, between two frames, every pixel of the new frame differs from the pixel at the same position in the previous frame. If, for a general display system, the system can only update those pixels that have changed when comparing the new frame to the current frame, it can avoid many unnecessary memory accesses. A broad range of applications can take advantage of such selective screen updating. The information about which pixels need to be updated can e.g. be provided in a header of the frame that is sent to the video memory wherein the content dependent updating will be performed, i.e. for example the frame buffer or the on-display memory. Video decoding applications can be optimized to only update those parts of the screen that have changed. Applications requiring user input, such as calendars, spreadsheets, and word processors can take advantage of the fact that user input is most of the time limited to a small part of the screen area. One embodiment provides a modification to the software that generates the data for a video memory of the system, which may be e.g. a frame buffer, but which also may be the display panel itself. Instead of writing the entire video memory, the software only updates the pixels that have changed. This approach yields a substantial reduction of the number of memory operations. In order to apply this optimization to the frame buffer, e.g. in existing systems comprising a frame buffer, it has to be taken into account that it will only work correctly on systems that use a single frame buffer. Systems that use a double frame buffer to avoid display artifacts on the display panel, such as e.g. the LCD, first will have to be modified so that a single frame buffer can be used. This requires some kind of synchronization between the application and the controller that generates the signals for the display panel, e.g. the LCD panel. In practice, this can be realized by making sure that the production of new data in the data source is never slower than the read by the display controller to the display unit.

Alternatively, optimization is performed on the level of the display panel, i.e. whereby the memory cells corresponding to the different pixels of the display panel are updated only if the value of the memory cell needs to be changed. This may both be done in systems comprising another video memory, external to the display panel, or in systems wherein the video memory associated with the memory cells of the different pixels of the display panel is the only video memory present. In systems comprising both a video memory external to the display panel, such as e.g. a frame buffer, and a video memory at the level of the display panel, the optimisation may be performed both at the level of the external video memory and at the pixel level video memory. Content dependent updating, as described in one inventive aspect, is especially useful if only a fraction of the screen is to be updated between different subsequent frames. Content dependent updating may be useful for both for suntil images and for streaming video. If e.g. an MPEG4-coded video stream is used, only the content that has been changed when compared to the previous image, which may e.g. be found in the decoded macroblocks of a P-frame, can be sent to the screen.

In other words, in the present method the number of memory accesses, e.g. the number of write operations from the processing unit to one of the writable memories, typically may be minimized such that only the new updates are overwriting the current image info in the writable memory component. The new updates thereby are the display data for those pixels that need to display differently between the current frame and the next frame of information to be displayed. This optimization may not only be performed in the writable memory component of the display panel, but also in the writable memory component external to the display panel. If e.g. a frame buffer is present, only the modified pixel display data, i.e. the display data corresponding with pixels that need to display different information between the current frame to be displayed and the next frame to be displayed, may be transferred to the frame buffer.

The different methods and systems for reducing the power consumption of a display system are non-providing one or more intermediate memories, updating the display pixel level video memory, i.e. the on-display panel memory, and/or the video memory external to the display depending on the content of the screen and/or providing a separate connection between the display panel and the processing unit. By combining these methods maximal power savings can be obtained. Only a system wide approach wherein the different methods are applied in combination to each other allows to achieve the absolute minimum number of data transfers. In the following, different examples of devices comprising a display system will be described, wherein one or more inventive aspects are applied in order to reduce the power consumption of the device.

A typical example of a system which may use a power optimized display unit, may be e.g. a Personal Digital Assistant. Typically, many PDA applications such as calendars, contact management tools, e-book readers and office tools show very static display behavior. This means that screen updates occur infrequently. Typical examples are updating of a screen only when a page of an e-book is turned, or updating of a spreadsheet whereby only the cell that is edited needs to be modified. Personal Digital Assistants typically are equipped with a display having an intermediate display size of 240×320 pixels. These systems typically are powered using a battery. Different methods can be applied for optimizing the power consumption of such systems, either applying one of these methods separately or by combining several methods. Optimization of the power consumption based on content dependent updating of a screen can be applied by adjusting the software used for displaying information on the display. Optimization of the power consumption based on reduction of the number of intermediate memories in the display system of the Personal Digital Assistant may be done by a hardware related architectural change, combined with software related changes. Such a hardware related architectural change may e.g. be using a display provided with a per-pixel memory such as e.g. an active matrix driven display or a display with specifically introduced memory elements for each display. Using the display panel as a large RAM memory, based on the memory elements for each of the pixels of the display panel is supported by the fact that the PDA typical has a fixed format display panel.

Another example of a system wherein power optimization may play an important role is in systems having a small form factor, such as e.g. a watch, whereon a display application is to be run. Such applications may be e.g. a visual information providing application such as e.g. a global positioning system application, a textual news providing application, a route mapping application, etc. In systems having a small size, there is only a limited space available for a battery. Currently portable devices with a battery having limited battery lifetime typically only have a very simple user interface. An example thereof are GPS watches having only a very simple user interface on a black-and-white LCD display. These systems would largely benefit from display systems having a reduced power consumption. Again different methods for reducing power consumption could be applied to these systems, whereby only one method may be applied or different power consumption optimization methods may be combined. The different methods that may be applied are content dependent updating of the video memory, not providing one or more intermediate video memory components and/or providing a separate bus for connecting the display panel directly with the processing unit. The usability of such a device would be lifted an order of magnitude if the user could get a graphical feedback of the application run on the system, e.g. the GPS application. There are various applications of such devices. One can imagine a golf course that is displayed on a graphical color display. The map itself is static, only the ‘current location’ cursor needs to be updated from time to time. The latter therefore would largely benefit from content dependent updating of the video memory. This will again allow for tremendous power savings that will, e.g. enable the integration of color displays in low-power devices such as a watch. Similar advantages are obtained for e.g. GPS systems used for hiking and biking.

Another example of a system that benefits of the different embodiments is a Universal Serial Bus (USB) display unit. Such a display unit can be attached to a host system by means of a Universal Serial Bus (USB) connection. Connecting the display triggers the software driver module on the host system that maps the display memory into the memory map of the processing unit. The signal transfer rate using an USB connection depends on the type of USB connection. Typically 1.5 Mbits/sec (USB1.0) or 12 Mbits/sec (USB1.1) can be transferred with the USB 1 standard, while USB 2.0 allows an additional transfer speed being 480 Mbits/sec. Transfer furthermore is determined by the protocol used to divide the bus time, e.g. control, interrupt, bulk or isochronous transfer. A typical example of a USB display application that optimally can use the power consumption optimizations as discussed above is an e-book interface. An e-book application typically updates the entire screen at once and then waits for user input, e.g. to load the new content. With memory cells located underneath every pixel, the display panel behaves as a static memory. The content consequently has only to be written once and remains static in between screen updates. The infrequent screen update requirement minimizes power consumption by reducing the data transfers from host to screen.

It is to be noted that the examples provided above are only provided by way of example, the invention not being limited thereto. There are many other examplary systems that may benefit from certain inventive aspects described herein, such as an iPod system providing calender, game, address book applications, an advanced mobile telephone, a portable device combining streaming video with streaming audio, etc.

As a further illustration of the above described embodiments, experimental results for a two-step optimization method for existing platforms is presented. Measurements on a multimedia application show that, on average, power savings of 72% can be obtained on the display related memory accesses.

A two-step optimization method for building a multimedia terminal that eliminates redundant memory accesses when interfacing to the display unit is applied. In the first step, the frame buffer access is optimized. Only parts of the screen that are modified between frames are written to the frame buffer. This optimization reduces the number of memory accesses between processor and frame buffer. Hence, the power consumption of the system is reduced. In a second step, a new hardware architecture that eliminates the frame buffer is presented. This second step enables a further reduction of the power consumption. In the most optimal case of a static image between consecutive frames, all memory accesses are eliminated.

The experimental results are obtained for proposed set-ups provided on a test platform of which the power consumption can be measured. Both dedicated test software and an existing compressed video decoder application are used to evaluate the impact of the optimizations. The experimental results were obtained using a readily available prototyping platform. The impact of the optimizations on real hardware thus is measured. The obtained test results furthermore indicate that similar results can be obtained for other display systems. The latter can be concluded by extrapolating the test results. The hardware and software used in the measurement set-up is further described in more detail.

The hardware set-up consists of a test platform which is an XSCALE PXA250-based prototyping platform with 64 MB of SDRAM and a Tvia CyberPro 5205G-50 video processor. The video buffer of the Tvia is mapped in the memory space of the processor. This allows to emulate e.g. an OLED display if the Tvia video processor is considered to be a display unit. The operating system of the set-up is Linux. The Tvia video processor generates a PAL video output signal. This video output signal is used to display the output of the test set-up on a standard TV screen. To determine the power consumption of the display related memory accesses, the current drained by the entire platform was monitored at the power supply. The power required by the actual display unit, i.e. the TV screen, is not taken into account.

Three different software applications are tested. The first two are dedicated test applications. The third application is an MPEG-4 video decoder that has been developed in our research group. This decoder allowed us to verify the predicted gain in a real-life application and is described in detail further on. The test applications are written to be able to measure the impact of every step of the proposed optimization. In a first test case, the influence of optimizing the frame buffer access is measured. The second test case allowed us to verify the direct video memory access optimization.

In the first test case, the influence of the content dependent optimizations were studied with a set-up as schematically illustrated in FIG. 13a. An application running on the processor of the test platform generates screen data. This data is written into a frame buffer that is allocated in main memory of the system, indicated by arrow A in FIG. 13a. To emulate the frame buffer to LCD panel transfers, the application copies the frame buffer content to the Tvia video controller, indicated by arrow B and C in FIG. 13a. Eight frames per second are generated and written to the frame buffer (640×480 pixels, 16 bits per pixel). The frame rate has been selected in order not to overload any hardware system limits, such as bus capacity or processor load. The transfers from the frame buffer to the Tvia also occur eight times per second. The impact of the memory transfers on the power usage is evaluated in five different cases, ranging from updating the entire display to doing no update at all.

In the second test case, the possible energy savings by integrating an OLED display with per-pixel memory are evaluated on the same hardware setup. The frame buffer is eliminated, i.e. not provided in the display system, and the test application writes its data immediately to the Tvia video processor. Again, the impact of the display related memory accesses on the power usage is evaluated in five different cases, ranging from a full screen update to doing no update at all. The block scheme of the test software shows that the only display related transfer is the one from the CPU to the Tvia video processor, as shown e.g. in FIG. 13b.

The results are obtained, using the above described test cases with the above described hardware and software.

A comparison of the measurement results between the non-optimized setup (with frame buffer and full screen update) and the set-up where the per-pixel memory is emulated (no frame buffer and a static image) shows a difference in power consumption of 770 mW. As an indication, the idle power consumption of the platform is 5.3 W. It is important to understand that, as low power design techniques get more and more accepted, the CPU and its peripherals will start consuming a smaller amount of the total power. The memory related power consumption is not expected to drop that fast. This means that the impact of the memory operations on the power consumption will even become larger in future systems.

In order to represent the measurement results, all further figures are expressed as a percentage of the maximal difference in power consumption, 770 mW.

For the first test case, using the optimized frame buffer access, the possible gain in power consumption ranges between 0% (when all pixels are updated) and 71% (when no pixels are updated) compared to the original power consumption of the display related memory accesses. On average, 36% power is saved. This can e.g. be seen in table 1, showing the power gained due to optimization of the display-related memory accesses.

TABLE 1

| | % savings using per- | % savings using content |
|---|---|---|
| % screen update | pixel memory display | dependent optimization |
| 100 | 0 | 45 |
| 75 | 18 | 59 |
| 50 | 36 | 72 |
| 25 | 53 | 86 |
| 0 | 71 | 100 |

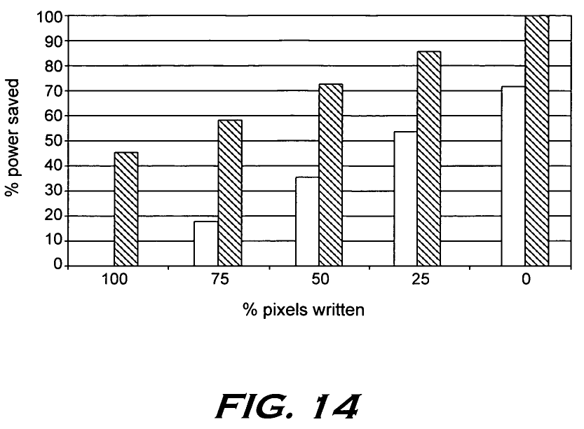

The second test case, with per-pixel memory display and optimized access, allows for power savings between 45% (the entire screen is updated) and 100% (in case of a static image). On average, a platform based on this architecture uses 72% less power for the display related memory accesses. The results are indicated in FIG. 14, showing the relative amount of power consumption saved, for both content dependent updating in a prior art system (white bars) and combined content dependent updating in a system without frame buffer (dashed bars).

For the interpretation of the results considering existing displays such as e.g. LCDs, it has to be taken into account that the refresh rate of our “display unit” (the Tvia) is lower than what is used in current systems. The effect of that is that the absolute measured gain by introducing the new display will be even larger in existing systems. The high throughput on the LCD panel bus due to the high refresh rate will cause a higher power drain than the energy consumption that occurs in our test set-up. The absolute value of the power saving in a device also depends on the frame size, the frame rate and the system architecture (e.g. the type of RAM, the length of the system buses, . . . ).

Assuming that on average 50% of the pixels need to be refreshed between two frames, the obtained power savings are 277 mW (36%) for the content dependent optimization (first test case) and 554 mW (72%) for the version with the per-pixel memory display (the second test case).

In order to study the effect of the optimizations on a realistic MPEG-4 video decoder, measurements on a realistic MPEG-4 video decoder application have been performed, run on the XScale platform. These measurements confirm the obtained results. The proposed test-bed contains video at different bit rates and with varying degrees of motion: from mother and daughter, a head and shoulders type sequence to calendar and mobile, a highly complex sequence with multiple, heterogeneous motion. All sequences are compressed using an MPEG-4 Simple Profile coder which uses a hybrid video block-based algorithm exploiting temporal and spatial redundancy in subsequent frames. Three types of 8×8 blocks can occur in a frame: (i) intra blocks contain only independent texture information, (ii) inter blocks use motion compensated prediction and (iii) skipped blocks, a special kind of inter blocks, in which none of the pixels change compared to the previous frame. Hence these last blocks do not need a screen update and can exploit the two proposed optimizations. Table 2 represents the amount of blocks requiring a screen update, varying with the complexity of the video sequence to be displayed. Table 2 lists the relative amount of intra, inter and skipped 8×8 blocks in the MPEG-4 Simple Profile video sequences. The amount of skipped blocks varies from virtually zero for highly complex to almost 80% for low motion video. For an average sequence, around 75% of the image is updated. This leads to respectively 18% and 59% power saving for the two optimizations.

TABLE 2

| Sequence | Bitrate (kbps) | Intra | Intercoded | Interskipped |
|---|---|---|---|---|
| Mother & daughter | 101 | 1.0 | 21.5 | 77.5 |
| Mother & daughter | 287 | 1.0 | 30.4 | 68.6 |
| Foreman | 334 | 1.4 | 69.3 | 29.3 |
| Foreman | 935 | 1.4 | 79.9 | 18.8 |
| Calendar & mobile | 1641 | 1.0 | 92.9 | 6.0 |
| Calendar & mobile | 3998 | 1.0 | 95.5 | 3.5 |

Some embodiments are particularly useful for battery powered devices with a display as main user interface, such as e.g. a handheld multimedia terminal which is portable, although the invention is not limited thereto.

It is an advantage of the above described embodiments that display systems and methods for using display systems are provided that allow for power saving by decreasing the required number of memory accesses to put a frame on the screen.

It is also an advantage of several of the above described embodiments of that both hardware design a software design is optimized in order to obtain a reduced power consumption.

It is furthermore an advantage of the embodiments that, for display systems incorporated in a battery powered device, the battery autonomy can be increased. It is also an advantage that energy savings up to 72% of the power can be obtained, compared to traditional display system setups.

It is to be understood that although preferred embodiments, specific constructions and configurations, as well as materials, have been discussed herein for devices according to the present invention, various changes or modifications in form and detail may be made without departing from the scope and spirit of this invention. For example, although certain embodiments particularly describe power optimized display systems, they also relate to the corresponding methods for using such display systems. Furthermore, although separate display systems are described, the display systems may be incorporated in other devices.

What is claimed is:

1. A display system comprising:
a processing unit;
a display unit comprising a display panel;
an image data processing path configured to transfer information to the display panel, the image data processing path comprising no more than one writable memory component external to the display panel, the writable memory component adapted for storing at least a single image frame; and
a control unit configured to control access of the writable memory component such that generation or transmission of a new image to the writable memory component is postponed until the display panel has received the pixels of the current image from the writable memory.

2. The display system according to claim 1, wherein the writable memory component is a single buffer memory component.

3. The display system according to claim 1, wherein the system is adapted for content dependent updating of the display panel.

4. The display system according to claim 2, wherein the system is adapted for content dependent updating of the display panel.

5. The display system according to claim 3, wherein the content dependent updating is a partial update of the image.

6. The display system according to claim 4, wherein the content dependent updating is a partial update of the image.

7. A method of displaying information, the method comprising:
receiving information to be displayed,
converting the information into an image to be displayed using no more than one writable memory component external to a display, and
displaying the image,
wherein the converting comprises controlling access to the writable memory component external to the display by postponing generation or transmission of a new image to the writable memory component until the display has received the pixels of the current image from the writable memory.

8. The method according to claim 7, wherein the converting of the information into an image to be displayed comprises converting the information into an image to be displayed using a single buffer memory component.

9. The method according to claim 7, wherein the converting comprises:
computing an image whereby at least one pixel value for a new frame is determined; and
updating pixel display data when the pixel display data is changed.

10. The method according to claim 8, wherein the converting comprises
computing an image whereby at least one pixel value for a new frame is determined; and
updating pixel display data when the pixel display data is changed.

11. The method according to claim 9, wherein the information is block oriented video information, each block comprising a header, and wherein computing an image comprises indicating in the header of the block which pixel information has been changed.

12. The method according to claim 10, wherein the information is block oriented video information, each block comprising a header, and wherein computing an image comprises indicating in the header of the block which pixel information has been changed.

13. A method of modifying a data source for an application, the method comprising reducing, for power reduction, a plurality of memory accesses for displaying data on a display panel by producing new data in the data source not slower than previously produced data is received by the display.

14. The method according to claim 13, wherein producing of new data in the data source further comprises postponing generating or transmitting a new image until the display panel has read the pixels of the current image.

15. The method according to claim 13, further comprising content dependent updating the data to be displayed in a single frame buffer.

16. The method according to claim 14, further comprising content dependent updating the data to be displayed in a single frame buffer.

17. The method according to claim 13, further comprising content dependent updating in the display panel of the data to be displayed.

18. The method according to claim 14, further comprising content dependent updating in the display panel of the data to be displayed.

19. The method according to claim 15, wherein the content dependent updating of the data comprises performing no more than partial updating of the data.

20. The method according to claim 16, wherein the content dependent updating of the data comprises performing no more than partial updating of the data.

21. The method according to claim 17, wherein the content dependent updating of the data comprises performing no more than partial updating of the data.

22. The method according to claim 18, wherein the content dependent updating of the data comprises performing no more than partial updating of the data.

23. The method according to claim 19, wherein the data comprises block oriented video information, wherein the partial updating of the data is based on an indication in a header of a block about which pixel information has been changed.

24. The method according to claim 20, wherein the data comprises block oriented video information, wherein the partial updating of the data is based on an indication in a header of a block about which pixel information has been changed.

25. The method according to claim 21, wherein the data comprises block oriented video information, wherein the partial updating of the data is based on an indication in a header of a block about which pixel information has been changed.

26. The method according to claim 22, the data comprises block oriented video information, wherein the partial updating of the data is based on an indication in a header of a block about which pixel information has been changed.

27. A display system comprising:
means for receiving information to be displayed,
means for displaying an image,
means for converting the information into an image to be displayed using no more than one writable memory component external to the displaying means, and
wherein the means for converting comprises means for controlling access to the writable memory component by postponing generation or transmission of a new image to the writable memory component until the displaying means has read the pixels of the current image from the writable memory.

28. A display system comprising:
a processing unit;
a display panel; and
a dedicated display bus configured to transfer information directly from the processing unit to the display panel.
